(19) United States
(12) Patent Application Publication
(10) Pub. No.: US 2002/0124815 A1
(43) Pub. Date: Sep. 12, 2002

(54) Cooling structure of cylinder head and method for manufacturing cylinder head

(75) Inventors: Fumihisa Ishiguro, Nagoya-shi (JP); Hiroyuki Ikuta, Nisshin-shi (JP); Norihiro Amano, Kasugai-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 10/083,148

(22) Filed: Feb. 27, 2002

(30) Foreign Application Priority Data
Mar. 6, 2001 (JP) 2001-062244
Mar. 8, 2001 (JP) 2001-064887

(51) Int. Cl. F02F 1/36

(52) U.S. Cl. 123/41.82 R

(57) ABSTRACT

In a cylinder head, a cooling water passage with a circular shape (an elliptical shape) in cross section in radial direction is formed at an area (lower layer deck) closer to a combustion chamber than a water jacket in which a cooling water flows.

The cooling water passage of the cylinder head is formed by casting by providing a hollow core in a mold and removing the hollow core.

### INCORPORATION BY REFERENCE

The disclosure of Japanese patent Application Nos. 2000-062244 filed on Mar. 6, 2001 and 2001-064887 filed on Mar. 8, 2001 including the specification, drawings and abstract are incorporated herein by reference in their entirety.

### BACKGROUND OF THE INVENTION

1. Field of the Invention

The present invention relates to a cooling structure in an engine and a method for manufacturing a cylinder head.

2. Description of the Related Art

Generally, in a water-cooled engine, a water jacket is provided inside of a cylinder head and cylinder block to cool the cooling water flowing therethrough. For example, a Japanese patent Laid-open Publication No. 9-242602 discloses a cylinder head in which a shape of the water passage of the water jacket is devised to control a water flow so that a cooling water may flow through an area where the ambient temperature becomes high such as area between the engine valves.

In the engine, combustion chamber defined by the cylinder head and cylinder block, etc., is supplied with fuel and the engine is driven by the combustion energy generated when the fuel is combusted. Therefor, a cylinder head portion close to the combustion chamber is prefer to be cooled mainly because a temperature of the cylinder head portion becomes high due to heat produced by the fuel combustion.

Accordingly, at the cylinder head portion close to the combustion chamber the inner space of the water jacket can be extended toward the combustion chamber side to improve the cooling efficiency at the portion. By this structure, the high temperature area is cooled by the cooling water in the water jacket which flows through the combustion chamber side.

However, to extend the inner space of the water jacket partially may lead to a complicated structure of the inner shape of the water jacket and such complicated shape of the water jacket may slow down the flow rate of the cooling water. This will cause a stagnation or residual foreign materials left in the water jacket and it may be difficult to effectively cool the area of the cylinder head close to the combustion chamber.

Further, the area of the cylinder head close to the combustion chamber may receive a large force based on the combustion pressure generated during the fuel combustion. Accordingly, when the water jacket has a complicated shape at the inner space, the stress is concentrated upon the area of the cylinder head by the force based on the combustion pressure and the cylinder head may affect the fatigue strength thereof.

Bores or holes provided on the cylinder head and the cylinder block as passages for flowing the cooling water or as connecting or assembling holes for threading bolts thereinto are usually formed by die-casting. For example, the cylinder head mold is formed by providing a sand made core formed by sand and after pouring process, the cores are removed from the mold by sand baking or sand stripping shake-out to form the cylinder head or the block with various holes thereon.

During the pouring, the melt metal (molten metal) in the mold becomes solidified in accordance with the temperature drop to form a cylinder head. However, when the temperature drop of the molten metal is slow, the solidification of the metal becomes slow to reduce the density of the material of the engine structure. It is, therefore, difficult to produce a cylinder head with high strength.

Particularly when using sand core for manufacturing the engine structure having a various holes, it is further difficult to produce a cylinder head with high strength.

It is because the thermal conductivity of the sand core is very small (difficult to be cooled) and the temperature drop of the molten metal is retarded due to the heat of the sand core to influence on the density of the material.

### SUMMARY OF THE INVENTION

Considering the above, it is an object of the present invention to provide a cooling structure of the cylinder head and a method for manufacturing the cylinder head which can effectively cool the area where the combustion chamber is closely located by restricting the strength drop of the cylinder head.

A cooling structure of the cylinder head according to one aspect of the present invention includes a water jacket provided in the cylinder head for flowing a cooling water for the engine and a cooling water passage having a circular shape in cross section in radial direction, separately formed from the water jacket, and provided in the cylinder head at an area closer to a combustion chamber of the engine than the water jacket.

According to this aspect of the invention, since the cooling water passage has a circular shape in cross section in radial direction, the cooling water passing through the passage flows without generating stagnation and stress concentration will be hard to be generated when the force based on the combustion pressure is applied on the area closer to the combustion chamber than the water jacket of the cylinder head.

Accordingly, the reduction of the fatigue strength of the cylinder head according to the stress concentration can be prevented or restricted and yet, the area of the cylinder head close to the combustion chamber can be effectively cooled by the cooling water flowing in the cooling water passage.

According to a second aspect of the present invention, method for manufacturing a cylinder head of the engine includes steps of providing a hollow core capable of flowing a coolant therethrough in a mold of the cylinder head of the engine, pouring a molten metal into the mold, and introducing the coolant through the inside of the hollow core to form a passage for a cooling water of the engine in the cylinder head.

According to the second aspect of the invention, during the manufacturing process of the cylinder head, the coolant is introduced into the hollow core upon pouring and therefore, the temperature drop of the molten metal in the mold is accelerated. The solidification speed of the molten metal is slowed down to prevent the drop of density of material for the cylinder head. Thus the strength of the cylinder head is increased.

### BRIEF DESCRIPTION OF THE DRAWINGS

FIG. 1 is an enlarged cross sectional view showing the vicinity of combustion chamber of the engine applied for a cooling structure of the cylinder head of an embodiment of the present invention;

FIG. 2 is a perspective view of an intake valve, exhaust valve, fuel injection nozzle, and a cooling water passage showing the positional relation thereof;

FIG. 3 is an enlarged cross sectional view showing the cooling water passage in cross section in radial direction;

FIG. 4 is an outline view of another example of the cooling water passage showing the shape in extending direction;

FIG. 5 is a perspective view of a hollow core used for manufacturing the cylinder head;

FIG. 6 is a side sectional view of the hollow core showing the core being provided in a mold; and,

FIG. 7 is a plane sectional view of the hollow core showing the core being provided in the mold.

### DETAIL DESCRIPTION OF THE PREFERRED EMBODIMENTS

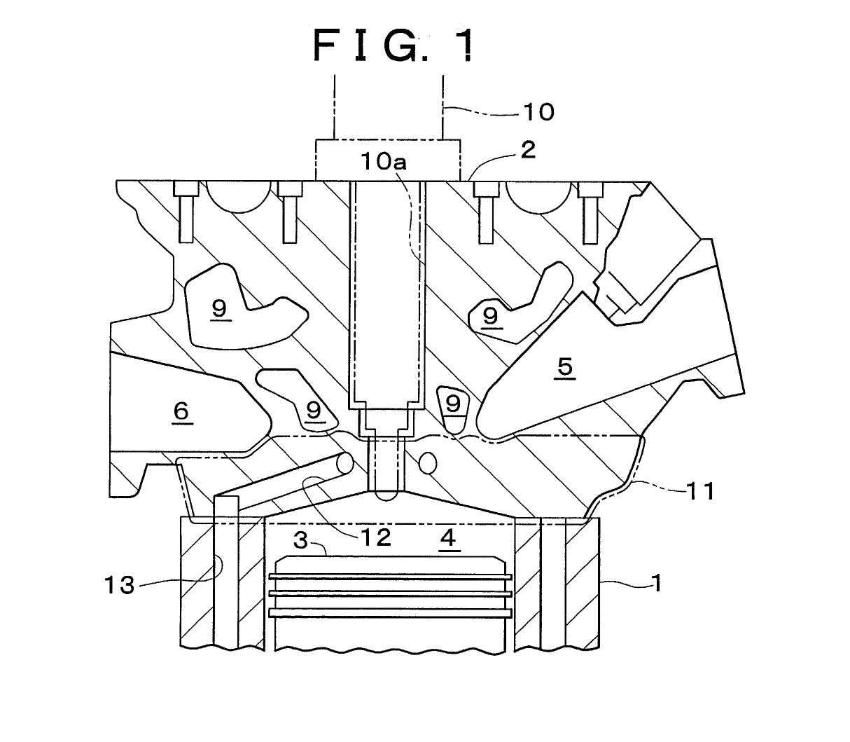

Referring now to an embodiment of the present invention applied to a cylinder head made of casting aluminum for water cooled type multiple-cylinder diesel engine, with reference to the attached drawings of FIG. 1 through FIG. 3, FIG. 1 shows an enlarged cross sectional view showing the vicinity of a combustion chamber of one cylinder of the engine. This engine includes a cylinder head 2 assembled on upper side of a cylinder block 1 and a piston 3 reciprocal within the cylinder block 1. A combustion chamber 4 is defined by the cylinder head 2 and the piston 3 and is to be supplied with a fuel from a fuel injection nozzle 10. The fuel supplied into the combustion chamber 4 is combusted to reciprocate the piston 3 by the combustion energy generated upon combustion of the fuel to eventually drive the engine.

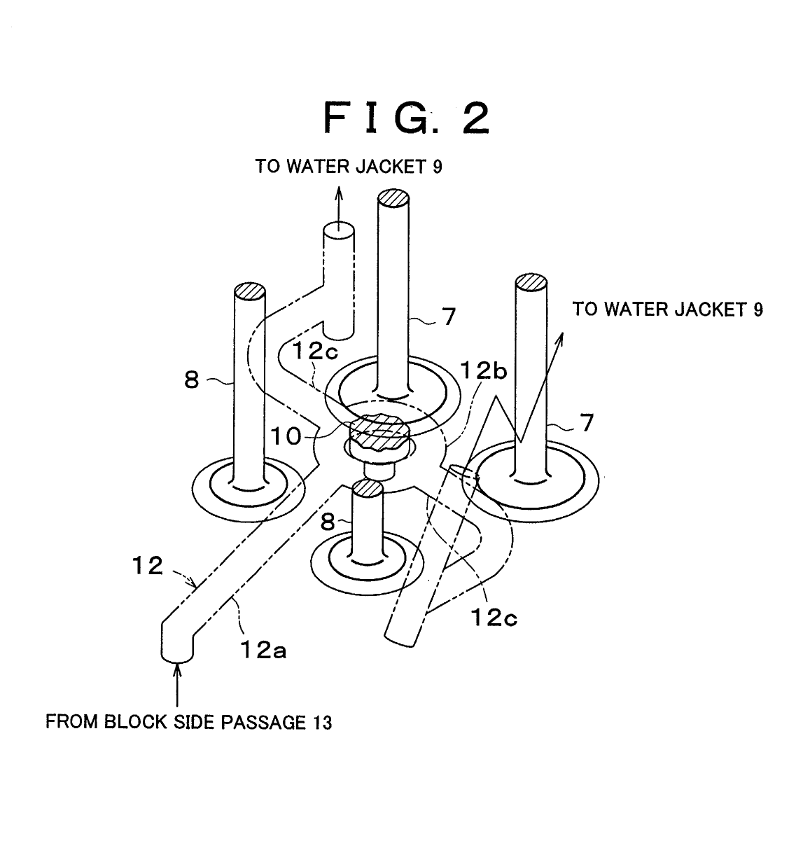

In the combustion chamber 4, a intake passage 5 and an exhaust passage 6 are connected under the branched condition (In FIG. 1, only one side of each branched intake and exhaust passages is shown). The intake passage 5 and the combustion chamber 4 are controlled to be in communication or to be interrupted by a intake valve 7 shown in FIG. 2 which is opened or closed by the driving of the engine. The exhaust passage 6 and the combustion chamber 4 are controlled to be in communication or to be interrupted by an exhaust valve 8 shown in FIG. 2 which is opened or closed by the driving of the engine.

As is shown in FIG. 1, the cylinder head 2 is provided with a water jacket 9 in which a cooling water flows. The water jacket 9 has a complicated profile not to be interfered with the intake passage 5, exhaust passage 6, or a hole 10a for accommodating the fuel injection nozzle 10. The cylinder head 2 is cooled by the cooling water flowing through the water jacket 9.

In the cylinder head 2, an area positioned close to the combustion chamber 4 indicated by a chain line shown in FIG. 1 (hereinafter the area is referred to as lower layer deck 11) receives heat generated according to the combustion of the fuel in the combustion chamber 4 and the temperature there becomes high. Accordingly, it is preferable to cool the lower layer deck 11 area intensively.

In order to intensively cool the lower layer deck 11, a cooling water passage 12 is formed on the lower layer deck 11 with a circular shape in cross section in radial direction according to the embodiment.

The cooling water passage 12 is independently provided at each cylinder and is positioned closer to the combustion chamber side than the water jacket 9. The distance (interval) from the passage 12 to the combustion chamber 4 is defined to be smaller than the distance (interval) from the passage to the water jacket 9. The cooling water passage 12 is connected to a block side passage 13 formed on each cylinder of the cylinder block 1 and the water jacket 9 of the cylinder head 2, respectively to connect the block side passage 13 and the water jacket 9.

The cooling water of the engine is discharged from a water pump (not shown) and passes through the block side passage 13, cooling water passage 12, and water jacket 9 in order, and cools down each portion of the engine, such as, the cylinder block 1, lower layer deck 11 and upper portion of the cylinder head 2. Since the cooling water passage 12 is independently provided in each cylinder, each lower layer deck 11 corresponding to each cylinder is cooled by the cooling water flowing through the cooling water passage 12. The cooling water passage 12 is formed by providing a core in a mold during the casting of the cylinder head 2. The detail of the manufacturing method of the cylinder head 2 by casting will be explained later.

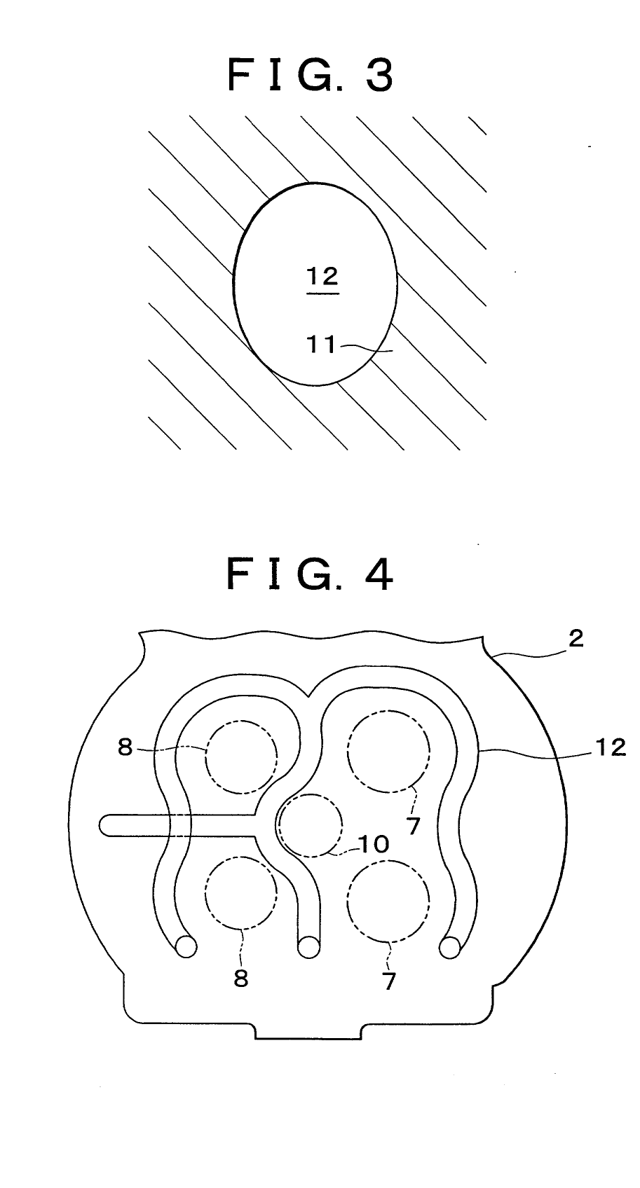

Next explaining the shape of cooling water passage 12 in extended direction and the shape in cross section in radial direction formed in one cylinder with reference to the attached drawings of FIG. 2 and FIG. 3:

FIG. 2 is a perspective view of the cooling water passage 12, the intake valve 7, the exhaust valve 8, and the fuel injection nozzle 10 showing the positional relation thereof.

As shown in FIG. 2, the cooling water passage 12 is provided with an introduction portion 12a which extends toward the block side passage 13 to introduce the cooling water from the block side passage 13 passing through the area between the two exhaust valves 8. The introduction portion 12a is connected to a circular portion 12b located around the fuel injection nozzle 10. The cooling water passage 12 further includes a pair of outlet portions 12c, 12c which extend from the circular portion 12b to the water jacket 9 passing through the space between the intake valve 7 and exhaust valve 8, respectively. The cooling water in the circular portion 12b flows out to the water jacket 9 through each outlet portion 12c located between the intake valve and the exhaust valve 8.

The cooling water in the cooling water passage 12 passes the space between the two exhaust valves 8, 8 for cooling a portion in vicnity of the valves 8 at the lower layer deck 11 (FIG. 1) and then passes around the fuel injection nozzle 10 for cooling a portion around the fuel injection nozzle 10 at the lower layer deck 11, and branched in two directions to pass each space between the intake valve 7 and the exhaust valve 8 for cooling a portion in vicnity of the valves. At the lower layer deck 11, the ambient temperature of the area surrounded by intake valves 7, exhaust valves 8 and fuel injection nozzle 10 has a tendency of becoming high. However, by structuring the cooling water passage 12 as above, these engine components are effectively cooled by the cooling water passing thereby.

To effectively cool the lower layer deck 11, it is preferable to increase the cross sectional area of the cooling water passage 12 in radial direction as large as possible. However, such increase of the cross section for the cooling water passage 12 which is located at area surrounded by the intake valve 7, the exhaust valve 8 and the fuel injection nozzle 10 is restricted due to the location thereof. Particularly, when the valve seats for the intake and exhaust valves 7, 8 have to be assembled at connecting portions of the intake passage 5 and the exhaust passage 6 with the combustion chamber 4, the cross sectional area of the cooling water passage 12 has to be reduced not to be interfered with the valve seats.

Instead of providing the valve seats, clad can be formed which has a very good abrasion resistance performance at each contacting portion of the intake and exhaust valves 7, 8 upon closing thereof in the cylinder head 2. The clad is formed by laser cladding method and is used as a valve seat.

When such clad portion can be used as the valve seat, the cross sectional area in radial direction of the cooling water passage can be increased to its maximum allowable limit to more effectively cool the lower layer deck 11.

The cross section shape in radial direction of the cooling water passage 12 will be explained hereinafter with FIG. 3 in addition to FIGS. 1 and 2. FIG. 3 shows an enlarged cross sectional view of the cross section profile of the cooling water passage 12 in radial direction.

The cooling water passage 12 is formed such that when the cross sectional shape becomes ellipse (elongated circle), the direction affected by a force based (vertical direction as viewed in FIGS. 1 and 3) on the combustion pressure generated upon combustion of the fuel in the combustion chamber 4 becomes long diameter of the ellipse in cross section. Accordingly, when the force based on the combustion pressure is applied to the lower layer deck 11, the rigidity of the cylinder head 2 (the lower layer deck 11) is sufficiently improved. In addition, by shaping the passage 12 in cross section in radial direction to be a circle (an ellipse), the stress concentration will not be easily generated on the lower layer deck 11 upon such force based on the combustion pressure and the drop of fatigue strength which would occur upon application of concentrated stress thereon can be refrained or avoided.

The effects according to the embodiment of this invention will be as follows:

(1) since the cooling water passage 12 with a circular (elliptical) shape in cross section in radial direction is formed on the lower layer deck 11, the cooling water in the cooling water passage can smoothly flow therethrough without stagnation and the stress concentration may be prevented or can be minimized which may occur when the force based on the combustion pressure affects on the portion closer to the combustion chamber than the water jacket of the cylinder head. Accordingly, the drop of fatigue strength of the lower layer deck 11 due to the concentrated stress can be avoided and at the same time the cooling effect of the lower layer deck 11 can be improved due to the smooth flow of the cooling water in the cooling water passage 12 without stagnation.

It should be noted that it may be preferable to provide the cooling water passage 12 in the cylinder head at the area where it receives larger force based on the combustion pressure than the other area. By providing the cooling water passage as above mentioned, the area of the cylinder head receiving the larger force can be effectively cooled and fatigue strength thereof can be increased compared to the condition under the high temperature (not sufficiently cooled). This can properly refrain the drop of strength of the cylinder head.

(2) closer the location of the lower layer deck 11 to the combustion chamber, the higher the temperature thereof becomes. However, the distance from the cooling water passage to the combustion chamber is set to be smaller than the distance to the water jacket 9 at the closest area thereof to the combustion chamber and accordingly, the area of the lower layer deck 11 where the temperature becomes high (combustion chamber side) can be effectively cooled.

(3) The area surrounded by the intake valves 7, exhaust valves 8, and fuel injection nozzle 10 in the lower layer deck 11 is positioned close to these intake and exhaust valves and is exposed to the heat generated by the fuel combustion in the combustion chamber 4. This will lead to the high temperature around the area. According to the embodiment, this area can be effectively cooled by the cooling water passage 12.

(4) Since the shape of the passage 12 in cross section in radial direction is an elongated circular shape (or elliptical shape) having a long diameter in the direction in which the force based on the combustion pressure is applied on the lower layer deck 11, accordingly high rigidity of the lower layer deck 11 (cylinder head 2) can be maintained even when such force is applied thereon.

(5) The cooling water passage 12 is used for connecting the block side passage 13 and the water jacket 9. This can eliminate any extra passages or conduits just for connecting purpose and the structure of the cooling passage for cooling water can be simplified.

(6) When the cooling water is used for cooling another cylinder after one of the cylinders is cooled, the temperature of the cooling water is gradually increased to generate cooling performance difference among the cylinders. It means that the performing uniform or equal cooling to each cylinder becomes difficult. However, since according to this embodiment, the cooling water passage 12 is formed independently on each cylinder, the cooling water used for cooling one lower layer deck 11 of the corresponding cylinder is not used for cooling another lower layer deck 11 of the corresponding cylinder thus avoiding the occurrence of such cooling performance difference among the lower layer decks of the cylinders. Further, it is possible to adjust the cooling performance (cooling level) of the respective lower layer decks 11 by changing the diameter of the cooling water passage 12 in each cylinder.

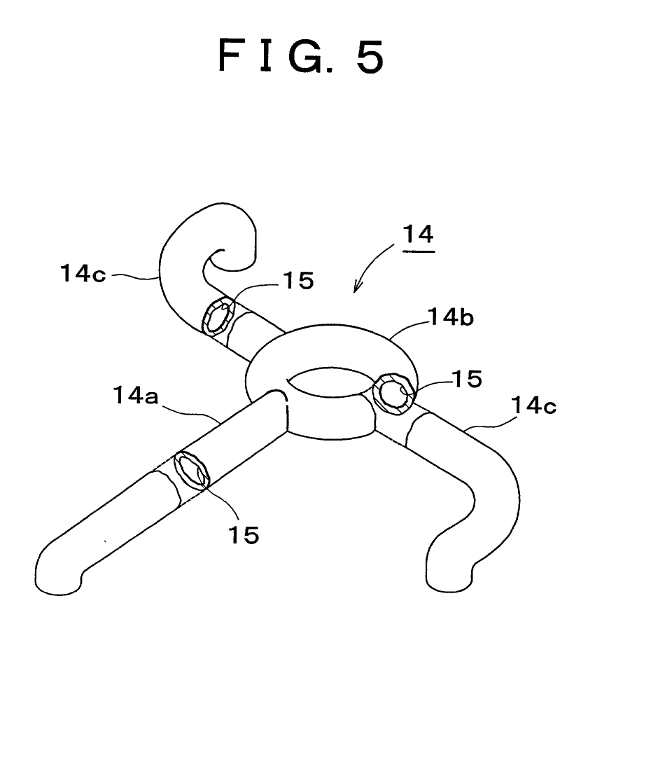

Next, explaining the method of manufacturing the cylinder head 2 by casting with reference to the attached drawings of FIG. 5 through FIG. 7:

The cylinder head 2 with the cooling water passage 12 is manufactured by the steps of casting with various cores in the mold and removing the cores. When the casting is performed by keeping the cores in the mold, the temperature of the molten metal in the mold is dropped to be solidified thereby to form holes or spaces at the portion corresponding to the cores. These formed holes or spaces are used for intake passage 5, exhaust passage, water jacket 9, a hole 10a for ignition plug (or fuel injection nozzle) and cooling water passage 12. FIG. 5 shows a core for forming the cooling water passage 12 (a hole).

The core 14 (hollow core) shown in FIG. 5 is made from a material which is expanded and collapsed by chemical reaction with water, such as calcium oxide. The material such as calcium oxide is pressurized by press forming and hardened to form the core 14. Thus formed hollow core 14 is of pipe shape and includes an introduction pipe portion 14a corresponding to the introduction portion 12a, a circular pipe portion 14b corresponding to the circular portion 12b, and an outlet pipe portion 14c corresponding to the outlet portion 12c of the cooling water passage 12. The inside hollow portion of the hollow core 14 forms a passage 15 for water flowing.

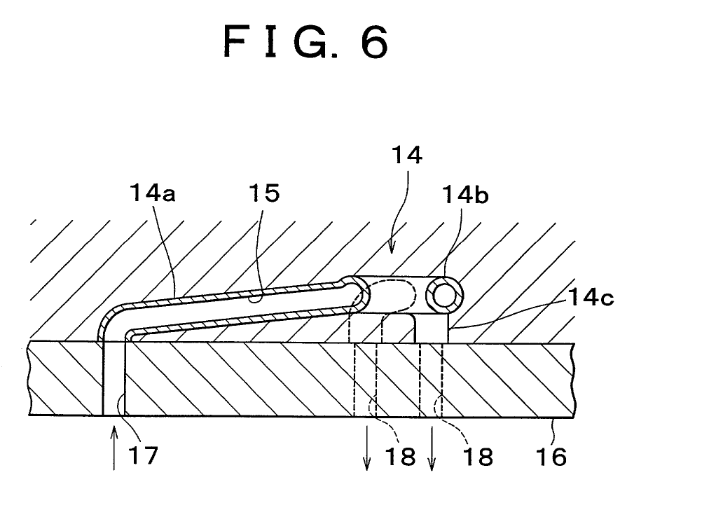

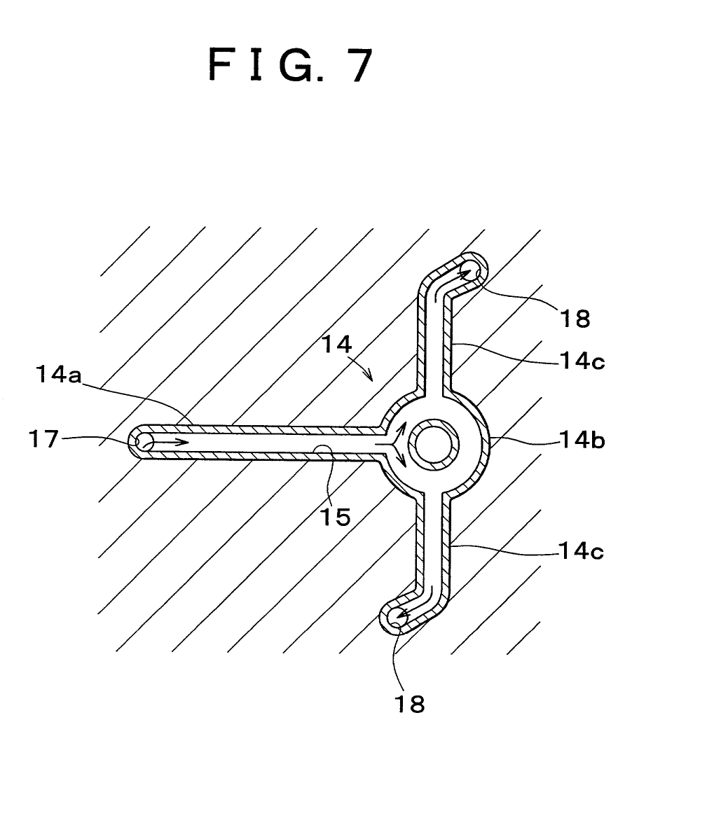

FIG. 6 and FIG. 7 show, respectively, a schematic side sectional view and a plane sectional view of the hollow core 14 provided in the mold for the cylinder head 2. As shown in FIGS. 6 and 7, the tip end of the introduction pipe portion 14a of the hollow core 14 provided in the mold is connected to a supply passage 17 formed in a lower die 16 and the tip end of the outlet pipe portion 14c is connected to a discharge passage 18 formed in the lower die 16. After casting process, when the temperature of the molten metal in the mold is dropped to begin the solidification of the molten metal which is in contact with the core 14, the cooling water is supplied from the supply passage 17 into the passage 15 in the core 14.

The cooling water supply to the passage 15 of the core 14 begins with the timing of solidification of the molten metal in contact with the core 14 caused by the temperature drop.

The cooling water supplied to the passage 15 passes inside of the introduction pipe portion 14a, circular pipe portion 14b, and outlet pipe portion 14c in turn and discharged to the discharge passage 18. The cooling water is supplied to the hollow core 14 to accelerate the temperature drop of the molten metal in the mold. Accordingly, the solidification speed of the molten metal is retarded by the temperature drop to restrict the reduction of the material density of the cylinder head 2.

Calcium hydroxide is generated by the chemical reaction of calcium oxide forming the core 14 and water when the cooling water is supplied into the hollow core 14. Upon generation of the calcium hydroxide the core 14 is expanded and collapsed and discharged with the water to the discharge passage 18, which promptly removes the core from the mold. The thickness of the core 14 is defined to a size to be easily collapsed, for example 1 to 3 mm, upon expansion when the cooling water is supplied to the passage 15.

According to the embodiment of the present invention, the following advantages are obtained:

(1) since the cooling water passage 12 is formed by the core provided in the mold upon casting of the cylinder head 2, the shape of the passage in extended direction can be formed to be a complicated profile, such as bent shape and the design choice for the shape in extended direction can be improved to be able to form a complicated shape shown in FIG. 2.

(2) During the manufacturing process of the cylinder head 2, the cooling water can be supplied into the passage 15 in the core 14 at casting process, the temperature drop of the molten metal in the mold can be accelerated to retard the solidification speed of the molten metal to prevent the density drop of the material of the cylinder head 2, which eventually improves the strength of the cylinder head 2.

(3) The temperature of the molten metal in the mold is dropped from the area in contact with the core 14 to the area far from the core 14. The slowest temperature drop area may be a cause of shrinkage cavity due to the shrinkage upon temperature drop. However, since the area of the cylinder head 2 surrounded by the cooling water passage 12 is first cooled by the cooling water flowing through the core 14 upon casting and can avoid the generation of the shrinkage cavities.

(4) Calcium hydroxide is generated by the chemical reaction of calcium oxide forming the core 14 and water when the cooling water is supplied into the hollow core 14. Upon generation of the calcium hydroxide, the core 14 is expanded and collapsed to promptly remove the core from the mold. Thus the prompt removal of the core from the mold can be achieved to shorten the time for manufacturing the cylinder head 2.

(5) Since the water supply to the hollow core 14 upon casting is initiated at the timing of solidification of the molten metal in the mold by the temperature drop, when the hollow core 14 is removed from the mold by the supply of the water the reaction of the water with the molten metal before the solidification can be prevented.

The method for manufacturing the cylinder head 2 can be achieved by the following method in addition to the method explained above.

For the material to form the core 14, a material which can be solved by the water may be used and instead of using water to be supplied into the passage 15 of the core 14 as a coolant, a coolant which solves the calcium oxide forming the hollow core 14, such as ammonium solution or acid solution can be used. In such cases, the hollow core 14 is removed by being solved with the coolant upon supply of the coolant into the passage 15 of the core 14.

The intake passage 5, exhaust passage 6, water jacket 9, block side passage 13, hole 10a of the ignition plug 10, passages for lubrication oil and holes for bolts are manufactured by the hollow core in which a coolant (water) is supplied.

According to another embodiment of the cooling structure of the cylinder head of the invention, the cooling water passage 12 can be formed by inserting a pipe shaped material which is different from the material of the cylinder head 2 upon casting of the head 2 instead of using the same material core for forming the cooling water passage 12.

It is not necessary to provide independent cooling water passage in each cylinder.

The cooling water passage 12 may be formed to pass through the space between the two intake valves 7, instead of two exhaust valves 8.

The cooling water passage 12 can be formed to pass through the other engine valves as shown in FIG. 4 in addition to the intake and exhaust valves 7, 8.

The cooling water passage 12 according to the embodiment includes the introduction portion 12a, circular portion 12b and outlet portion 12c, but such structure may be changed. For example, a semicircular portion can be used to connect the introduction portion 12a and the outlet portion 12c instead of the circular portion 12b.

Additional passage can be provided as a passage for connecting the block side passage 13 and the water jacket 9.

The shape of the cooling water passage 12 in cross section in radial direction can be changed from the elliptical shape to a shape having more round profile, or the width in direction crossing with the long diameter may be constant by a certain length in long diameter direction. As a cross section of the cooling water passage 12 in radial direction, when the shape is formed which has the width in direction crossing with the long diameter being constant by the certain length in long diameter direction, the stress concentration generated by a force based on the combustion pressure affecting on the lower layer deck 11 can be more effectively avoided.

What is claimed is:

1. A cooling structure for a cylinder head of an engine, comprising:
the cylinder head of the engine;
a water jacket provided in the cylinder head for flowing a cooling water for the engine and
a cooling water passage having a circular shape in cross section in radial direction, separately formed from the water jacket, and provided in the cylinder head at an area closer to a combustion chamber of the engine than the water jacket.

2. A cooling structure according to claim 1, wherein the cooling water passage is positioned having a distance to the combustion chamber being smaller than a distance to the water jacket.

3. A cooling structure according to claim 1, wherein the cooling water passage is provided to pass through the vicinity of an engine valve.

4. A cooling structure according to claim 3, wherein the engine has two sets of intake and exhaust valves as engine valves for each cylinder of the engine and wherein the cooling water passage includes a first passage passing through between the two exhaust valves and a second passage branched from the first passage in two directions and passing through between each intake valve and the exhaust valves.

5. A cooling structure according to claim 4, wherein the engine includes a fuel injection nozzle provided in a cylinder block for supplying the fuel to the combustion chamber for each cylinder and wherein the cooling water passage further includes a third passage extending in circular around the fuel injection nozzle for introducing the cooling water from the first passage and discharging the cooling water to the second passage.

6. A cooling structure according to claim 1, wherein the cooling water passage is of an elliptical shape in cross section in radial direction having a long diameter in direction receiving a force based on a combustion pressure generated according to the combustion of the fuel in the combustion chamber.

7. A cooling structure according to claim 1, further comprising a fourth passage provided in the cylinder block and through which the cooling water flows, wherein the cooling water passage is formed to connect the fourth passage and the water jacket.

8. A cooling structure according to claim 1, wherein the engine includes a plurality of cylinders and the cooling water passage is formed for each cylinder independently.

9. A cooling structure according to claim 1, wherein the cylinder head is manufactured by casting and the cooling water passage is formed by providing a core in a mold upon casting of the cylinder head.

10. A cooling structure according to claim 9, wherein the core is formed to be of a pipe shape and the cooling water passage is formed by providing a coolant flow in the core upon casting.

11. A cooling structure according to claim 10, wherein the cooling water passage is formed by providing the core, which is a hollow type and collapses in response to the coolant flow into the core.

12. A cooling structure according to claim 11, wherein the cooling water passage is formed by the hollow core which expands and collapses by a chemical reaction with the coolant.

13. A cooling structure according to claim 9, wherein the cooling water passage is formed by the core, which is a hollow type and resolves with the coolant.

14. A method for manufacturing a cylinder head of an engine, comprising the steps of providing a hollow core for flowing a coolant in a mold of the cylinder head of the engine, pouring molten metal into the mold, and flowing the coolant into the hollow core to form a passage in the cylinder head to flow a cooling water of the engine through the passage.

15. A method according to claim 14, wherein the hollow core has a circular shape in cross section in radial direction.

16. A method according to claim 14, wherein the hollow core is provided so that the passage is formed in the cylinder head at an area closer to a combustion chamber of the engine than a water jacket.

17. A method according to claim 16, wherein the engine has two sets of intake and exhaust valves as engine valves for each cylinder of the engine, the passage includes a first passage passing through between the two exhaust valves and a second passage branched from the first passage in two directions and passing through between each intake valve and the exhaust valves and wherein the hollow core includes a first pipe portion corresponding to the first passage and a second pipe portion corresponding to the second passage.

18. A method according to claim 14, wherein the hollow core is made by a material which collapses by the flowing of the coolant.

19. A method according to claim 18, wherein the hollow core is made by a material which expands and collapses by a chemical reaction with the coolant.

20. A method according to claim 14, wherein the hollow core is made by a material which solves with the coolant.

21. A method according to claim 14, wherein the flow of the coolant into the hollow core begins with the timing of solidification of a molten metal which is in contact with the hollow core.

22. A cylinder head manufactured according to the method of claim 14.
